(19) United States
(12) Patent Application Publication
(10) Pub. No.: US 2007/0068546 A1
(43) Pub. Date: Mar. 29, 2007

(54) Vibrating Pet Brush with Adjustable Teeth

(76) Inventor: Steven Lipawsky, Coral Springs, FL (US)

Correspondence Address: LOREN DONALD PEARSON, P.A., P.O. BOX 402571, MIAMI BEACH, FL, 33140-2571, US

(21) Appl. No.: 11/534,939

(22) Filed: Sep. 25, 2006

Related U.S. Application Data
(60) Provisional application No. 60/719,865, filed on Sep. 23, 2005.

(51) Int. Cl. A45D 24/00

(52) U.S. Cl. 132/119.1

(57) ABSTRACT

A comb for grooming hair includes a spine, a first row of teeth, and a second row of teeth. The spine defines an axis of the comb. The first row of teeth extends from the spine along the axis. Neighboring teeth define a respective space therebetween. The second row of teeth extends from the spine along the axis and overlaps the first row of teeth. Each pair of overlapping teeth, one from the first row and the other from the second row, forms a “combined tooth”. The width of the combined tooth and the space between each combined tooth can be adjusted to match the width of the hair being combed. To adjust the combined tooth width and spacing, the second row can be moved along the axis of the comb relative to the first row in order to adjust the spaces between.

### BACKGROUND OF THE INVENTION

1. Field of the Invention

The invention relates to brushes for grooming pets.

2. Description of the Related Art

Existing combs, especially those for combing pet hair, have teeth with fixed spacing. Any given comb is therefore only sized for one width of hair. Hair that is too narrow cannot be efficiently removed.

Gallanis et al., U.S. Pat. No. 3,794,050, teach a comb with two combs that oscillate out of phase with each other to great a wave motion that facilitates untangling hair. Placing the teeth against each other so as to adjust the space between the teeth of the comb is not taught.

Carty et al., U.S. Pat. No. 5,911,225, teach a braid detangling device that includes two teeth. The two teeth are moved so that they are adjacent to each other. The teeth are then inserted in a braid. The teeth are then spread to loosen the braid. The braid detangling device does not teach to adjust the space between teeth to the width of the hair and then pulling the comb through the hair at the set size.

Davis, Jr., U.S. Pat. No. 6,668,758, teach an Animal Hair De-Matter. The animal hair de-matter includes two combs that have a spine that is orthogonal to an axis of motion. The combs reciprocate along the axis closer to each other and then farther apart. The animal hair de-matter does not teach to adjust the spacing of between the teeth of the combs.

Revil, U.S. Pat. No. 5,915,391, teach an Electric Comb Having Oscillatory Movement. The electric comb has a single row of teeth. The teeth lift and fall relative to each other. The space between the teeth is not adjustable.

Golan et al., U.S. Pat. No. 5,343,881 teach a Hair Treatment Apparatus and Method. The hair treatment apparatus and method involve an oscillating comb for removing lice. The space between the teeth is not adjustable.

Golan et al., U.S. Pat. No. 5,078,157, teach an Oscillatory Hair Treatment Apparatus and Method. The oscillatory hair treatment apparatus and method teach an oscillating comb for removing lice. The space between the teeth is not adjustable.

Paccione, U.S. Pat. No. 3,384,096, teach an Oscillatory Teasing Comb. The Oscillatory teasing comb includes three rows of teeth. The rows of teeth oscillate to tease the hair. The teeth cannot be moved relative to each other to adjust the width of hair held between the teeth.

### BRIEF SUMMARY OF THE INVENTION

It is accordingly an object of the invention to provide a vibrating comb with adjustable teeth that overcomes the above-mentioned disadvantages of the heretofore-known devices and methods of this general type. Although envisioned for pets, the comb may be used on any subject especially where the width of hair being combed may vary.

With the foregoing and other objects in view there is provided, in accordance with the invention, a comb for grooming hair. The comb includes a spine, a first row of teeth, and a second row of teeth. The spine defines an axis of the comb. The first row of teeth extends from the spine along the axis. Neighboring teeth define a respective space therebetween. The second row of teeth extends from the spine along the axis and overlaps the first row of teeth. Each pair of overlapping teeth, one from the first row and the other from the second row, forms a “combined tooth”. The width of the combined tooth and the space between each combined tooth can be adjusted to match the width of the hair being combed. To adjust the combined tooth width and spacing, the second row can be moved along the axis of the comb relative to the first row in order to adjust the spaces between the teeth to adapt the spaces to a width of hair to be removed.

In accordance with a further object of the invention, the spine vibrates along the axis. The back and forth vibration, which is perpendicular to the direction that the brush is pulled, helps the comb to remove hair and separate even matted hair. To create the vibration, the comb can include an oscillator connected to the spine. To create the vibrations along the axis of the comb, the oscillator should have a flywheel rotating orthogonal to the axis.

In accordance with a further object of the invention, each of the rows has a plurality of teeth equidistantly spaced along said axis. In addition, the spaces between neighboring teeth are equidistant. By making the teeth equal width and equally spaced, the teeth can be adjusted so that the space between all of the teeth is equal to the width of the hair being combed.

Other features which are considered as characteristic for the invention are set forth in the appended claims.

Although the invention is illustrated and described herein as embodied in a vibrating pet brush with adjustable teeth, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic right side view of the comb according to the invention.

FIG. 2 is a right side section view of the comb taken along line II-II in FIG. 3.

FIG. 3 is a front side view of the comb.

FIG. 4 is an enlarged partial side view of the teeth in a first position.

FIG. 5 is an enlarged partial side view of the teeth in a second position.

### DETAILED DESCRIPTION OF THE INVENTION

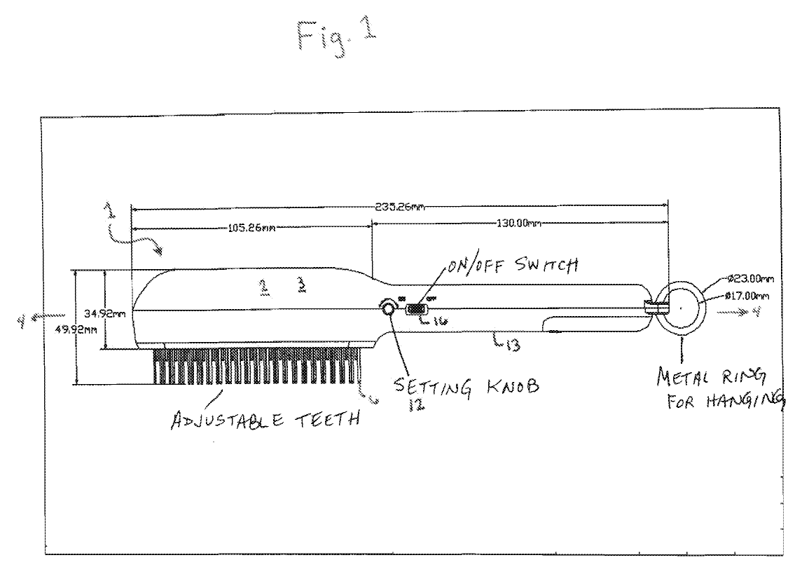

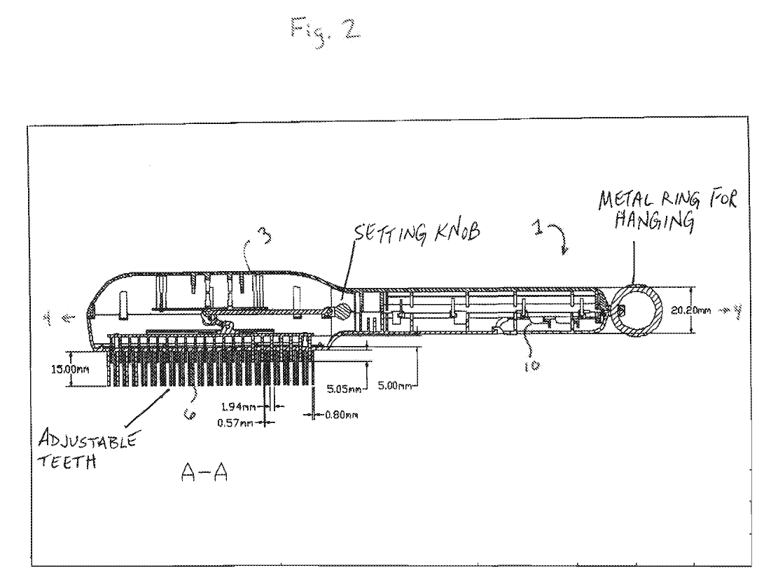

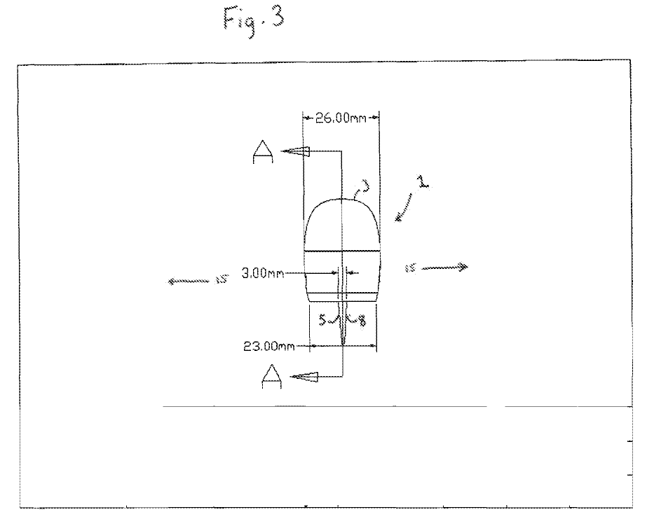

Referring now to the figures of the drawing in detail and first, particularly, to FIG. 1 thereof, there is seen a comb generally marked by reference number 1. The comb 1 includes a spine 3. The spine 3 defines an axis 4. The axis 4 is perpendicular to a combing direction 15. The combining direction 15 is the line over which the comb 1 is pulled.

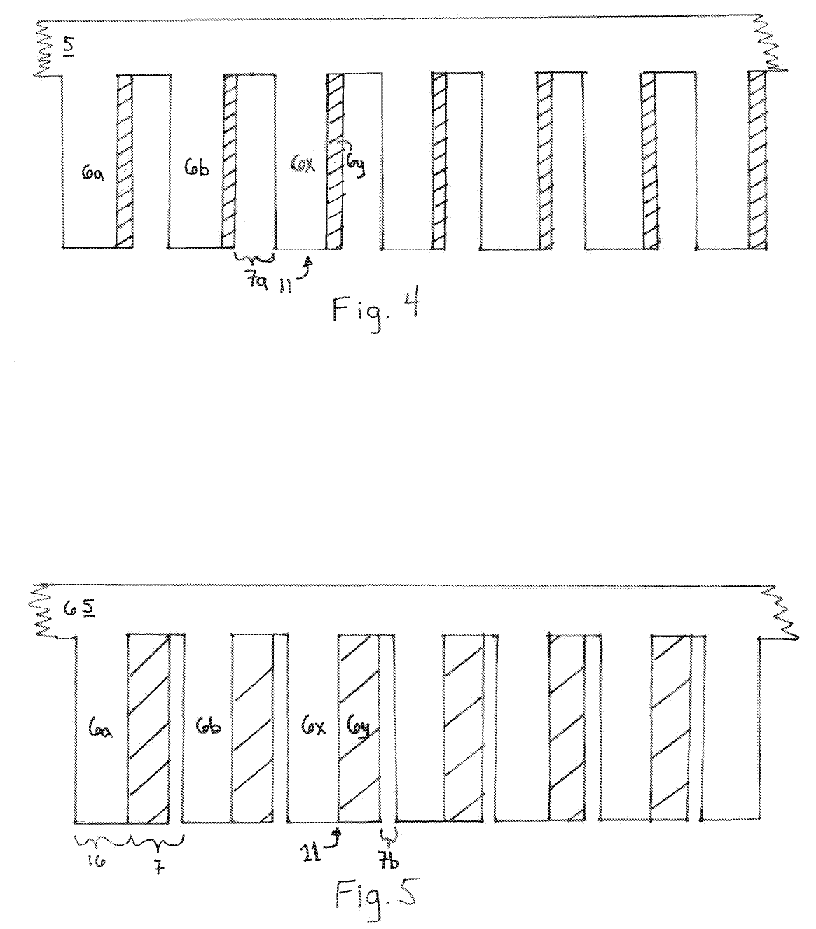

As seen in FIGS. 4-5, a first row 5 of teeth 6 is connected to the spine 3 and aligned along the axis 4. Likewise, a second row 8 of teeth 6 is connected to the spin 3 and aligned along the axis 4. The first row 5 and the second row 8 of teeth overlap each other. In a preferred embodiment, each of the teeth 6 has an equal width 16. In addition, in a preferred embodiment, the space 7 between neighboring teeth 6a and 6b is equidistant. Each tooth 6x in the first row 5 has a respective tooth 6y in the second row 8. The overlapping teeth 6x and 6y define a combined tooth 11. The space 7 between neighboring combined teeth is adjustable by moving the first row 5 relative to the second row 8 along the axis 4. FIG. 4 shows a relative wide space 7a between combined teeth 11. In contrast, FIG. 5 shows a relatively narrow space 7b between combined teeth 11.

By moving the rows 5 and 8 relative to each other, the space 7 between combined teeth 11 is adjusted. The space 7 is adjusted to correspond to the width of the hair being combed. By matching the space 7 to the width of the hair, dead hair is more like to be held by the brush and removed.

A handle 12 is attached to the spine 3. The handle allows the comb 1 to be held.

A knob 12 is disposed on the handle 12. The knob 12 is connected to the second row 5. Turning the knob 12 moves the second row 8 relative to the first row 5 along the axis 4 to adjust the space 7 between combined teeth 11.

A ring 14 is connected to the handle 12. The ring 14 can be attached to a lanyard or used to hang the comb 1 when not in use.

An oscillator 10 is disposed in the handle 13. The oscillator 10 includes a motor that turns acentric flywheel. The axis of the flywheel is orthogonal to the axis 4 and the teeth 6. The oscillator 10 causes the comb 1 to vibrate back and forth along the axis 4. The oscillation helps in the combing of thick and matted hair. Preferably, the motor is battery powered. A switch 16 is connected to the oscillator 10. The switch activates and deactivates the oscillator 10.

I claim:

1. A comb for grooming hair, comprising:
a spine defining an axis;
a first row of teeth extending from said spine along said axis, neighboring ones of said teeth defining a respective space therebetween; and
a second row of teeth extending from said spine along said axis and overlapping said first row of teeth, and being movable along said axis relative to said first row to adjust said spaces between said teeth to adapt said spaces to a width of hair to be removed.

2. The comb according to claim 1, wherein said spine vibrates along said axis.

3. The comb according to claim 2, further comprising an oscillator connected to said spine and rotating orthogonal to said axis.

4. The comb according to claim 1, wherein each of said rows has a plurality of said teeth.

5. The comb according to claim 1, wherein said teeth are equidistantly spaced along said axis.

6. The comb according to claim 1, wherein said spaces between said teeth are equidistant.

7. The comb according to claim 1, wherein each of said teeth in said first row overlaps a respective one of said teeth in said second row, said each pair of overlapping teeth combining to define a combined tooth.

8. The comb according to claim 1, further comprising a knob connected said second row of teeth, said knob being turnable to move said second row of teeth along said axis relative to said first row of teeth.

9. The comb according to claim 1, further comprising a handle for holding the comb connected to said spine.

10. The comb according to claim 9, further comprising a ring connected to said handle.
